(19) United States
(12) Patent Application Publication
(10) Pub. No.: US 2026/0255357 A1
(43) Pub. Date: Aug. 27, 2026

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Tao QI, Shenzhen (CN); Yang LI, Shenzhen (CN); Lin CHEN, Shenzhen (CN)

(73) Assignee: ZTE CORPORATION, Shenzhen (CN)

(21) Appl. No.: 19/532,897

(22) Filed: Feb. 6, 2026

Related U.S. Application Data
(63) Continuation of application No. PCT/CN2023/112062, filed on Aug. 9, 2023.

(51) Int. Cl. H04W 72/23

(52) U.S. Cl. CPC H04W 72/23

(57) ABSTRACT

A wireless communication method is disclosed. The method comprises receiving, by a wireless communication node from a network node, a message for a broadcast session, wherein the message comprises one or more user equipment, UE, types associated with the broadcast session; and allocating, by the wireless communication node to wireless communication terminals, resources based on the one or more UE types.

### CROSS-REFERENCE TO RELATED APPLICATIONS

This application claims the benefit of priority under 35 U.S.C. § 120 as a continuation of PCT Patent Application No. PCT/CN2023/112062, filed on August 9, 2023, the disclosure of which is incorporated herein by reference in its entirety.

### TECHNICAL FIELD

This document is directed generally to wireless communications, and in particular to 5^{th} generation (5G) communications or 6^{th} generation (6G) communications.

### BACKGROUND

RedCap (Reduced Capability) UE (User Equipment) indicates a user device in communication technology that operates with limited functionalities or features compared to standard UE devices. This reduction in capabilities could serve specific use cases, optimize resource utilization, or facilitate cost-effective communication solutions. However, configurations of the RedCap UEs is still a topic to be discussed.

### SUMMARY OF THE INVENTION

This document relates to methods, systems, and computer program products for a wireless communication.

One aspect of the present disclosure relates to a wireless communication method. In an embodiment, the wireless communication method includes: receiving, by a wireless communication node from a network node, a message for a broadcast session, wherein the message comprises one or more user equipment, UE, types associated with the broadcast session; and allocating, by the wireless communication node to wireless communication terminals, resources based on the one or more UE types.

Another aspect of the present disclosure relates to a wireless communication method. In an embodiment, the wireless communication method includes: transmitting, by a network node to a wireless communication node, a message for a broadcast session, wherein the message comprises one or more user equipment, UE, types associated with the broadcast session, and the message requests the wireless communication node to allocate resources to communication terminals based on the one or more UE types.

Another aspect of the present disclosure relates to a wireless communication method. In an embodiment, the wireless communication method includes: receiving, by a first wireless communication node from a second wireless communication node, a message for a Multicast-Broadcast Service, MBS, session, wherein the message comprises one or more user equipment, UE, types associated with the MBS session; and allocating, by the first wireless communication node to communication terminals, resources based on the one or more UE types.

Another aspect of the present disclosure relates to a wireless communication method. In an embodiment, the wireless communication method includes: transmitting, by a second wireless communication node to a first wireless communication node, a message for a Multicast-Broadcast Service, MBS, session, wherein the message comprises one or more user equipment, UE, types associated with the MBS session, and the message requests the first wireless communication node to allocate resources to communication terminals based on the one or more UE types.

Another aspect of the present disclosure relates to a wireless communication method. In an embodiment, the wireless communication method includes: transmitting, by a first wireless communication node to a second wireless communication node, point to multipoint, PTM, configuration information for a multicast session for wireless communication terminals in a reduced capability, RedCap, user equipment, UE type.

Another aspect of the present disclosure relates to a wireless communication method. In an embodiment, the wireless communication method includes: receiving, by a second wireless communication node from a first wireless communication node, point to multipoint, PTM, configuration information for a multicast session for wireless communication terminals in a reduced capability, RedCap, user equipment, UE type.

Another aspect of the present disclosure relates to a wireless communication node. In an embodiment, the wireless communication node includes a communication unit and a processor. The processor is configured to: receive, via the communication unit from a network node, a message for a broadcast session, wherein the message comprises one or more user equipment, UE, types associated with the broadcast session; and allocate, via the communication unit to wireless communication terminals, resources based on the one or more UE types.

Another aspect of the present disclosure relates to a wireless communication node. In an embodiment, the wireless communication node includes a communication unit and a processor. The processor is configured to: transmit, via the communication unit to a wireless communication node, a message for a broadcast session, wherein the message comprises one or more user equipment, UE, types associated with the broadcast session, and the message requests the wireless communication node to allocate resources to communication terminals based on the one or more UE types.

Another aspect of the present disclosure relates to a first wireless communication node. In an embodiment, the first wireless communication node includes a communication unit and a processor. The processor is configured to: receive, via the communication unit from a second wireless communication node, a message for a Multicast-Broadcast Service, MBS, session, wherein the message comprises one or more user equipment, UE, types associated with the MBS session; and allocate, via the communication unit to communication terminals, resources based on the one or more UE types.

Another aspect of the present disclosure relates to a second wireless communication node. In an embodiment, the second wireless communication node includes a communication unit and a processor. The processor is configured to: transmit, via the communication unit to a first wireless communication node, a message for a Multicast-Broadcast Service, MBS, session, wherein the message comprises one or more user equipment, UE, types associated with the MBS session, and the message requests the first wireless communication node to allocate resources to communication terminals based on the one or more UE types.

Another aspect of the present disclosure relates to a first wireless communication node. In an embodiment, the first wireless communication node includes a communication unit and a processor. The processor is configured to: transmit, via the communication unit to a second wireless communication node, point to multipoint, PTM, configuration information for a multicast session for wireless communication terminals in a reduced capability, RedCap, user equipment, UE type.

Another aspect of the present disclosure relates to a second wireless communication node. In an embodiment, the second wireless communication node includes a communication unit and a processor. The processor is configured to: receive, via the communication unit from a first wireless communication node, point to multipoint, PTM, configuration information for a multicast session for wireless communication terminals in a reduced capability, RedCap, user equipment, UE type.

Various embodiments may preferably implement the following features:

Preferably, the one or more UE types comprise one or more categories of UEs, and the one or more categories of UEs comprise at least one of: reduced capability, RedCap, UEs, non-RedCap UEs, or enhanced RedCap UEs, wherein each category of UEs is associated with different UE capability information.

Preferably, the one or more UE types comprise at least one of:

a bandwidth;

frequency information;

band information; or

coverage information.

Preferably, the bandwidth indicates a maximum scheduling bandwidth of one or more corresponding UEs, the frequency information indicates frequency information where a service of the broadcast session scheduled on, the band information indicates band information where a service of the broadcast session scheduled on, and the coverage information indicates coverage information for a service of the broadcast session.

Preferably, the bandwidth indicates a maximum scheduling bandwidth of one or more corresponding UEs, the frequency information indicates frequency information where a service of the MBS session scheduled on, the band information indicates band information where a service of the MBS session scheduled on, and the coverage information indicates coverage information for a service of the MBS session.

Preferably, a response message is transmitted from the first wireless communication node to the second wireless communication node indicating whether the resources are allocated successfully for at least one wireless communication terminal with a RedCap UE type among the wireless communication terminals in a cell.

Preferably, the PTM configuration information is transmitted via a Radio Resource Control, RRC, release message from the second wireless communication node to the wireless communication terminals.

The present disclosure relates to a computer program product comprising a computer-readable program medium code stored thereupon, the code, when executed by a processor, causing the processor to implement a wireless communication method recited in any one of foregoing methods.

### BRIEF DESCRIPTION OF THE DRAWINGS

The exemplary embodiments disclosed herein are directed to providing features that will become readily apparent by reference to the following description when taken in conjunction with the accompanying drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

FIG. 1 shows an example of a schematic diagram of a wireless communication terminal according to an embodiment of the present disclosure.

FIG. 2 shows an example of a schematic diagram of a wireless communication node according to an embodiment of the present disclosure.

FIGS. 3 to 8 show flowcharts of wireless communication methods according to some embodiments of the present disclosure.

### DETAILED DESCRIPTION

In some embodiments, NR (new radio) MBS (Multicast and Broadcast Service) may be used in 5G systems (5GS). MBS serves multiple UEs in a cell, efficiently utilizing point-to-multipoint transmission. In some approaches, there is no dedicated support for RedCap UEs, devices with reduced capabilities (e.g., limited bandwidth, processing, or RF capabilities). Some embodiments of the present disclosure provide methods to solve at least the following issues:
1. The gNB (gNodeB) lacks awareness of UE capabilities within a broadcast session, hindering efficient RedCap UE support. Some embodiments of the present disclosure provide enhancement of the NGAP interface between the core network and the gNB to make the gNB aware of detailed UE capabilities for optimal resource allocation.
2. Resource coordination between the gNB-CU (Centralized Unit) and the gNB-DU (Distributed Unit) requires attention. In some approaches, the UE capability for a broadcast session may not be transmitted from the gNB-CU to the gNB-DU, impacting scheduling decisions and session establishment for RedCap UEs.
2a. The same issue may extend to multicast sessions, particularly when the network decides to deliver multicast data for UEs in the RRC_INACTIVE state.

Some embodiments of the present disclosure provide methods addressing these issues, so that the 5GS can efficiently deliver Multicast and Broadcast Services, accommodating RedCap UEs and their reduced capabilities. Some embodiments of the present disclosure provide methods on resource allocation within the RAN (Radio Access Network), offering solutions for the F1, El, and NG interfaces. The Fl interface the links gNB-CU and the gNB-DU, the El interface connects the gNB-CU-CP (Control Plane) and the gNB-CU-UP (user Plane), while the NG interface enables communication between NG-RAN (Next Generation Radio Access Network) nodes.

In the present disclosure, RedCap UEs encompass various devices with reduced capabilities, while MBS sessions encompass both multicast and broadcast sessions.

In the paragraphs below, many aspects of the present disclosure will be described, but the present disclosure is not limited thereto.

### Aspect 1 – enhancement for gNB being not aware of UE capability of broadcast session

In some embodiments, the gNB receives a broadcast session setup or modification request message from 5GC (5G core network). The gNB allocates the resources based on the QoS (Quality of Service) information and service area information. Additionally, the broadcast session setup or modification request message includes the UE types that the broadcast session is aiming at or associated with. Based on the UE capability, the gNB allocates the corresponding resources for the UEs that fits the UE type, to ensure that the UEs are able to receive the broadcast data.

In some embodiments, the UE type may be the type of UE capability or category of UE capability, e.g., non-RedCap UE, RedCap UE, or enhanced RedCap UE. Each UE type/category can be associated with different UE capability information.

In some embodiments, the UE type may be the explicit UE capability information. In such a case, the UE type may include at least one of:

a bandwidth (which may further indicate the maximum scheduling bandwidth for the UEs that the broadcast session is aiming at or associated with),

frequency information (which may further indicate the frequency information that the service of the broadcast session may be scheduled on),

band information (which may further indicate the frequency information that the service of the broadcast session may be scheduled on), or

coverage information (which may further indicate the coverage information for the broadcast service, and for example, the coverage information can be a coverage radius).

In some embodiments, there might be more than one UE type in the broadcast session setup or modification request message, i.e., a combination of different UE capabilities. In some cases, the broadcast service is aiming at different UE types simultaneously. For example, the broadcast service is to be delivered to non-RedCap UEs (which can be with 100MHz bandwidth), and the RedCap UEs (which can be with a limited bandwidth capability, e.g., 20MHz).

In some embodiments, the gNB takes this information (e.g., the UE type) into account, and may be or maybe not able to schedule the UEs with a configuration that fits the corresponding UE types.

In some embodiments, a method may include one or more configurations or operations below:

the gNB receives a broadcast session setup or modification request message from 5GC;

the broadcast session setup or modification request message includes the UE types that the broadcast session is aiming at; and/or

the gNB allocates the resources based on the UE capability.

In some embodiments, the UE type is the type of UE capability or the category of UE capability, and the type or category of UE includes at least one of non-RedCap UE, RedCap UE, or enhanced RedCap UE. Each UE type/category can be associated with different UE capability information.

In some embodiments, the UE type is explicit UE capability information, in which it could include the at least one of:

bandwidth (which further indicates the maximum scheduling bandwidth for the UE that the broadcast session is aiming at),

frequency information (which further indicates the frequency information that the broadcast service may be scheduled on),

band information (which further indicates the frequency information that the broadcast service may be scheduled on), or

coverage information (which further indicates the coverage information for the broadcast service, and the coverage information can be a coverage radius).

In some embodiments, there are more than one UE type in the broadcast session setup or modification request message, i.e., a combination of different UE capabilities.

### Aspect 2 - F1AP (F 1 Application Protocol) supports RedCap UEs

In some embodiments, the Broadcast Context Setup or modification message is transferred from the gNB-CU to the gNB-DU.

The gNB-DU allocates the resources based on the QoS (Quality of Service) information and service area information. Additionally, the broadcast session setup or modification request message includes the UE types that the broadcast session is aiming at or associated with. Based on the UE capability, the gNB-DU allocates the corresponding resources for the UEs that fits the UE type, to ensure that the UEs are able to receive the broadcast data.

In some embodiments, the UE type may be the type of UE capability or category of UE capability, e.g., non-RedCap UE, RedCap UE, or enhanced RedCap UE. Each UE type/category can be associated with different UE capability information.

In some embodiments, the UE type may be the explicit UE capability information. In such a case, the UE type may include at least one of:

a bandwidth (which may further indicate the maximum scheduling bandwidth for the UEs that the broadcast session is aiming at or associated with),

frequency information (which may further indicate the frequency information that the service of the broadcast session may be scheduled on),

band information (which may further indicate the frequency information that the service of the broadcast session may be scheduled on), or

coverage information (which may further indicate the coverage information for the broadcast service, and for example, the coverage information can be a coverage radius).

In some embodiments, there might be more than one UE type in the Broadcast Context Setup or modification message, i.e., a combination of different UE capabilities. In some cases, the broadcast service is aiming at different UE types simultaneously. For example, the broadcast service is to be delivered to non-RedCap UEs (which can be with 100MHz bandwidth), and the RedCap UEs (which can be with a limited bandwidth capability, e.g., 20MHz).

In some embodiments, the gNB-DU takes this information (e.g., the UE type) into account, and may be or maybe not able to schedule the UEs with a configuration that fits the corresponding UE types.

In some embodiments, the gNB-DU sends the response message to the gNB-CU about whether the resource allocation is successfully in one cell. In some cases, the gNB-DU is not able to allocate the resource for RedCap UEs in one cell but is able to allocate the resources for the non-RedCap UEs. This might be the result of resource fragmentation in the cell, and the gNB-DU needs larger bandwidth for the broadcast session, i.e., RedCap UEs are not able to receive the broadcast session due to the larger bandwidth requirement. In such a case, the gNB-DU reports a resource allocation failure to the gNB-CU. In some cases, the gNB-DU uses a separate indication (e.g., list) of whether the resource allocation is successful to the gNB-CU for RedCap UEs.

In some embodiments, a method may include one or more configurations or operations below:

the gNB-DU receives an MBS Context Setup or modification message from the gNB-CU;

the MBS Context Setup or modification message includes the UE types that the MBS session is aiming at; and/or

the gNB-DU allocates the resources based on the UE capability.

In some embodiments, the UE type is the type of UE capability or the category of UE capability, and the type or category of UE includes at least one of non-RedCap UE, RedCap UE, or enhanced RedCap UE. Each UE type/category can be associated with different UE capability information.

In some embodiments, the UE type is explicit UE capability information, in which it could include the at least one of:

bandwidth (which further indicates the maximum scheduling bandwidth for the UE that the MBS session is aiming at),

frequency information (which further indicates the frequency information that the MBS service may be scheduled on),

band information (which further indicates the frequency information that the MBS service may be scheduled on), or

coverage information (which further indicates the coverage information for the MBS service, and the coverage information can be a coverage radius).

In some embodiments, there are more than one UE type in the MBS Context Setup or modification message, i.e., a combination of different UE capabilities.

In some embodiments, the gNB-DU sends the response message to the gNB-CU indicating whether the resource allocation is successful for the MBS session in one cell for the UEs with the RedCap UE type.

### Aspect 2a – F 1AP supports RedCap UEs

In some embodiments, the transmission of the UE type described can be applied to a multicast session.

In some embodiments, for the multicast session, the configuration can be delivered to UEs in the RRC_CONNECTED state, and UEs in the RRCJNACTIVE state. In some embodiments, the UEs may be configured with the PTM (point to multipoint) configuration in an RRC (Radio Resource Control) release message to be used for UEs in the RRC _INACTIVE state. In some embodiments, the PTM configuration may be a pre-configuration for the UEs when the session is activated. In some embodiments, the network may configure the UEs with such a pre-configuration when the session is deactivated, e.g., to speed up the MBS data reception of UEs upon the session activation. In some embodiments, the lower layer part of the PTM configuration is provided by the gNB-DU. In some embodiments, the gNB-DU may also transmit information the lower layer part of the PTM configuration to the gNB-CU. In some embodiments, for different types of UEs, the lower layer part of the PTM configuration may be different and need to be transferred to the gNB-CU separately.

In some embodiments, the lower layer PTM configuration described above, may include the RLC (Radio Link Control), MAC (Medium Access Control), and Physical layer configurations for UEs to correctly receive the MBS data.

In some embodiments, a method may include:

the gNB-DU sends, to the gNB-CU, the lower layer part of the PTM configuration which is to be delivered to the UE in the RRC release message for the RedCap UE type.

In some embodiments of the present disclosure, to better support RedCap UEs, the gNB may be aware of the types of UEs associated with the MBS session, or more specifically, the gNB may be aware of the detailed UE capability, so that the gNB is able to allocate and schedule the resource for RedCap UEs. In some embodiments, the enhancement or configuration on the interface (e.g., the NGAP interface between the core network and the gNB) is needed to allow the core network to indicate the gNB about the associated UE capability of the broadcast session.

In some embodiments of the present disclosure, the F1 interface is enhanced or configured to enable the UE capability associated with the MBS session to be transferred from the gNB-CU to the gNB-DU. In some embodiments, the gNB-DU may get different scheduling results for the RedCap UEs and the non-RedCap UEs, e.g., resource establishment failed for the RedCap UEs in one cell. In some embodiments, the gNB-DU may inform the scheduling results for the RedCap UEs and the non-RedCap UEs to the gNB-CU separately.

In some embodiments of the present disclosure, for the multicast session, the scheduling results of the pre-configured PTM configuration for the RRC_INACTIVE reception may be different for the RedCap UEs and the non-RedCap UEs. In some embodiments, the gNB-DU may inform the pre-configured PTM configuration for the RedCap UEs and the non-RedCap UEs to the gNB-CU separately.

In the paragraphs below, details will be described along with some examples, but the present disclosure is not limited to the example below.

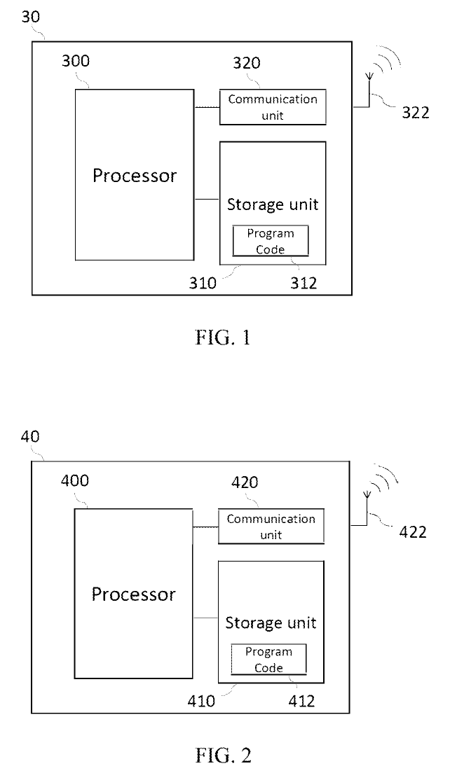

FIG. 1 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may be used to implement the UE described in this disclosure. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 or via wiring.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described in this disclosure. In some embodiments, the processor 300 and the communication unit 320 collaboratively perform the operations described in this disclosure. For example, the processor 300 performs operations and transmit or receive signals, message, and/or information through the communication unit 320.

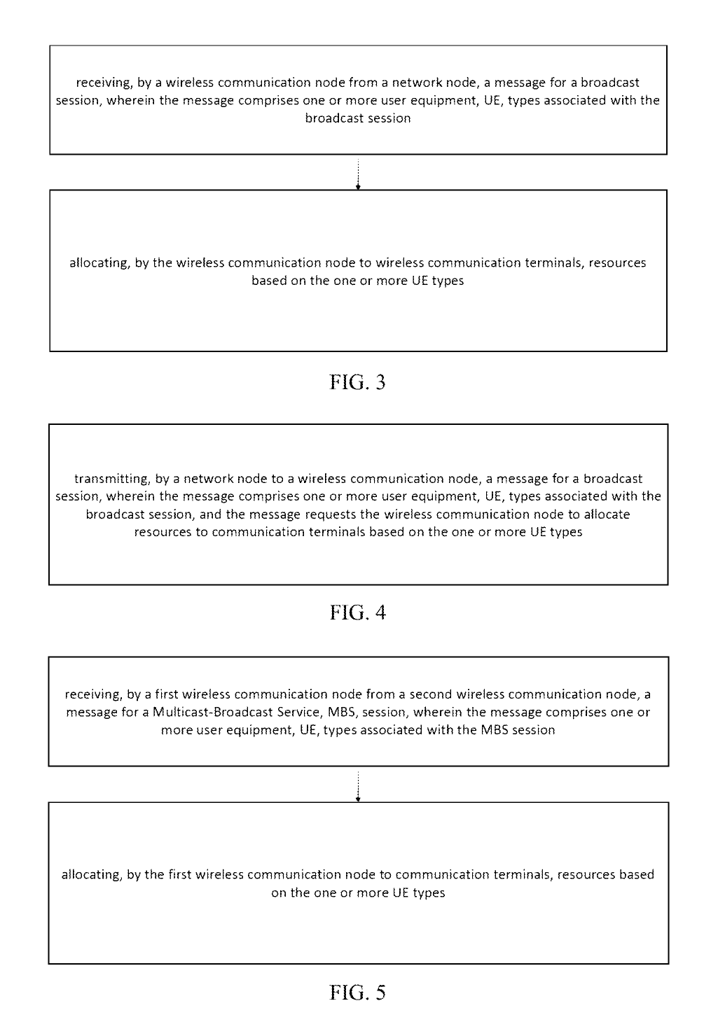

FIG. 2 relates to a diagram of a wireless communication node 40 according to an embodiment of the present disclosure. The wireless communication node 40 may be a satellite, a base station (BS), a gNB, a gNB-CU, a gNB-DU, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may be used to implement the gNB, the gNB-CU, the gNB-DU, the core network, the network, or the network node described in this disclosure. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 410 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an embodiment, the communication unit 420 transmits and receives the signals via at least one antenna 422 or via wiring.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the gNB, the gNB-CU, the gNB-DU, the core network, the network, or the network node described in this disclosure. In some embodiments, the processor 400 and the communication unit 420 collaboratively perform the operations described in this disclosure. For example, the processor 400 performs operations and transmit or receive signals through the communication unit 420.

A wireless communication method is also provided according to an embodiment of the present disclosure. In an embodiment, the wireless communication method may be performed by using a wireless communication node (e.g., a gNB). In an embodiment, the wireless communication terminal may be implemented by using the wireless communication node 40 described in this disclosure, but is not limited thereto.

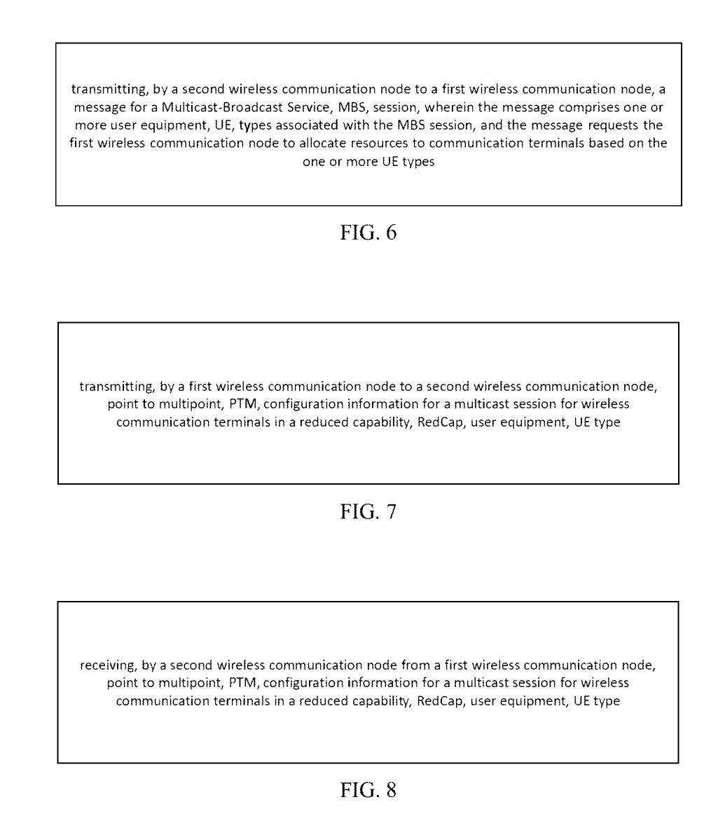

Referring to FIG. 3, in an embodiment, the wireless communication method includes: receiving, by a wireless communication node from a network node, a message for a broadcast session, wherein the message comprises one or more user equipment, UE, types associated with the broadcast session; and allocating, by the wireless communication node to wireless communication terminals, resources based on the one or more UE types.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a network node). In an embodiment, the wireless communication node may be implemented by using the wireless communication node 40 described in this disclosure, but is not limited thereto.

Referring to FIG. 4, in an embodiment, the wireless communication method includes transmitting, by a network node to a wireless communication node, a message for a broadcast session, wherein the message comprises one or more user equipment, UE, types associated with the broadcast session, and the message requests the wireless communication node to allocate resources to communication terminals based on the one or more UE types.

Details in this regard can be ascertained with reference to the paragraphs above, and will not be repeated herein.

A wireless communication method is also provided according to an embodiment of the present disclosure. In an embodiment, the wireless communication method may be performed by using a first wireless communication node (e.g., a gNB-DU). In an embodiment, the wireless communication terminal may be implemented by using the wireless communication node 40 described in this disclosure, but is not limited thereto.

Referring to FIG. 5, in an embodiment, the wireless communication method includes: receiving, by a first wireless communication node from a second wireless communication node, a message for a Multicast-Broadcast Service, MBS, session, wherein the message comprises one or more user equipment, UE, types associated with the MBS session; and allocating, by the first wireless communication node to communication terminals, resources based on the one or more UE types.

Details in this regard can be ascertained with reference to the paragraphs above, and will not be repeated herein.

A wireless communication method is also provided according to an embodiment of the present disclosure. In an embodiment, the wireless communication method may be performed by using a second wireless communication node (e.g., a gNB-CU). In an embodiment, the wireless communication terminal may be implemented by using the wireless communication node 40 described in this disclosure, but is not limited thereto.

Referring to FIG. 6, in an embodiment, the wireless communication method includes: transmitting, by a second wireless communication node to a first wireless communication node, a message for a Multicast-Broadcast Service, MBS, session, wherein the message comprises one or more user equipment, UE, types associated with the MBS session, and the message requests the first wireless communication node to allocate resources to communication terminals based on the one or more UE types.

Details in this regard can be ascertained with reference to the paragraphs above, and will not be repeated herein.

A wireless communication method is also provided according to an embodiment of the present disclosure. In an embodiment, the wireless communication method may be performed by using a first wireless communication node (e.g., a gNB-DU). In an embodiment, the wireless communication terminal may be implemented by using the wireless communication node 40 described in this disclosure, but is not limited thereto.

Referring to FIG. 7, in an embodiment, the wireless communication method includes: transmitting, by a first wireless communication node to a second wireless communication node, point to multipoint, PTM, configuration information for a multicast session for wireless communication terminals in a reduced capability, RedCap, user equipment, UE type.

Details in this regard can be ascertained with reference to the paragraphs above, and will not be repeated herein.

A wireless communication method is also provided according to an embodiment of the present disclosure. In an embodiment, the wireless communication method may be performed by using a second wireless communication node (e.g., a gNB-CU). In an embodiment, the wireless communication terminal may be implemented by using the wireless communication node 40 described in this disclosure, but is not limited thereto.

Referring to FIG. 8, in an embodiment, the wireless communication method includes: receiving, by a second wireless communication node from a first wireless communication node, point to multipoint, PTM, configuration information for a multicast session for wireless communication terminals in a reduced capability, RedCap, user equipment, UE type.

Details in this regard can be ascertained with reference to the paragraphs above, and will not be repeated herein.

In some embodiments, the wireless communication terminal used in the present disclosure may indicate the UE described above.

In some embodiments, the wireless communication node used in the present disclosure may indicate the gNB described above.

In some embodiments, the network node used in the present disclosure may indicate the network, the core network, or a node in the network or core network described above.

In some embodiments, the first wireless communication node used in the present disclosure may indicate gNB-DU described above.

In some embodiments, the second wireless communication node used in the present disclosure may indicate gNB-CU described above.

In some embodiments, the message for the broadcast session used in the present disclosure may indicate the broadcast session setup or modification request message described above.

In some embodiments, the message for the MBS session used in the present disclosure may indicate the MBS Context Setup or modification message described above.

In some embodiments, the PTM configuration information used in the present disclosure may indicate the lower layer part of the PTM configuration described above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is understood that, in the present disclosure, the term “and/or” or symbol “/” may include any and all combinations of one or more of the associated listed items. For example, A and/or B and/or C includes any and all combinations of one or more of A, B, and C, including A, B, C, A and B, A and C, B and C, and a combination of A and B and C. Likewise, A/B/C includes any and all combinations of one or more of A, B, and C, including A, B, C, A and B, A and C, B and C, and a combination of A and B and C.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
receiving, by a wireless communication node from a network node, a message for a broadcast session, wherein the message comprises one or more user equipment (UE) types associated with the broadcast session; and
allocating, by the wireless communication node to wireless communication terminals, resources based on the one or more UE types.

2. The wireless communication method of claim 1, wherein the one or more UE types comprise one or more categories of UEs, and the one or more categories of UEs comprise at least one of: reduced capability, RedCap, UEs, non-RedCap UEs, or enhanced RedCap UEs, wherein each category of UEs is associated with different UE capability information.

3. The wireless communication method of claim 1, wherein the network node comprises a second wireless communication node, and the broadcast session comprises a Multicast-Broadcast Service (MBS) session.

4. The wireless communication method of claim 1, wherein the one or more UE types comprise at least one of:
a bandwidth;
frequency information;
band information;
or coverage information.

5. The wireless communication method of claim 4, wherein the bandwidth indicates a maximum scheduling bandwidth of one or more corresponding UEs, the frequency information indicates frequency information where a service of the broadcast session scheduled on, the band information indicates band information where a service of the broadcast session scheduled on, and the coverage information indicates coverage information for a service of the broadcast session.

6. A wireless communication method comprising:
transmitting, by a network node to a wireless communication node, a message for a broadcast session, wherein the message comprises one or more user equipment (UE) types associated with the broadcast session, and the message requests the wireless communication node to allocate resources to communication terminals based on the one or more UE types.

7. The wireless communication method of claim 6, wherein the one or more UE types comprise one or more categories of UEs, and the one or more categories of UEs comprise at least one of: reduced capability, RedCap, UEs, non-RedCap UEs, or enhanced RedCap UEs, wherein each category ofUEs is associated with different UE capability information.

8. The wireless communication method of claim 6, wherein the network node comprises a second wireless communication node, and the broadcast session comprises a Multicast-Broadcast Service (MBS) session.

9. The wireless communication method of claim 6, wherein the one or more UE types comprise at least one of:
a bandwidth;
frequency information;
band
information; or
coverage
information.

10. The wireless communication method of claim 9, wherein the bandwidth indicates a maximum scheduling bandwidth of one or more corresponding UEs, the frequency information indicates frequency information where a service of the broadcast session scheduled on, the band information indicates band information where a service of the broadcast session scheduled on, and the coverage information indicates coverage information for a service of the broadcast session.

11. A wireless communication node, comprising:
a communication unit; and
at least one processor configured to: transmit, via the communication unit to a wireless communication node, a message for a broadcast session, wherein the message comprises one or more user equipment, UE, types associated with the broadcast session, and the message requests the wireless communication node to allocate resources to communication terminals based on the one or more UE types.

12. The wireless communication node of claim 11, wherein the one or more UE types comprise one or more categories of UEs, and the one or more categories of UEs comprise at least one of: reduced capability, RedCap, UEs, non-RedCap UEs, or enhanced RedCap UEs, wherein each category of UEs is associated with different UE capability information.

13. The wireless communication node of claim 11, wherein the network node comprises a second wireless communication node, and the broadcast session comprises a Multicast-Broadcast Service (MBS) session.

14. The wireless communication node of claim 11, wherein the one or more UE types comprise at least one of:
a bandwidth;
frequency
information; band
information; or
coverage
information.

15. The wireless communication node of claim 14, wherein the bandwidth indicates a maximum scheduling bandwidth of one or more corresponding UEs, the frequency information indicates frequency information where a service of the broadcast session scheduled on, the band information indicates band information where a service of the broadcast session scheduled on, and the coverage information indicates coverage information for a service of the broadcast session.

16. A network node, comprising:
a communication unit; and
at least one processor configured to: transmit, via the communication unit to a wireless communication node, a message for a broadcast session, wherein the message comprises one or more user equipment (UE) types associated with the broadcast session, and the message requests the wireless communication node to allocate resources to communication terminals based on the one or more UE types.

17. The network node of claim 16, wherein the one or more UE types comprise one or more categories of UEs, and the one or more categories of UEs comprise at least one of: reduced capability, RedCap, UEs, non-RedCap UEs, or enhanced RedCap UEs, wherein each category of UEs is associated with different UE capability information.

18. The network node of claim 16, wherein the network node comprises a second wireless communication node, and the broadcast session comprises a Multicast-Broadcast Service (MBS) session.

19. The network node of claim 16, wherein the one or more UE types comprise at least one of:
a bandwidth;
frequency
information; band
information; or
coverage
information.

20. The network node of claim 19, wherein the bandwidth indicates a maximum scheduling bandwidth of one or more corresponding UEs, the frequency information indicates frequency information where a service of the broadcast session scheduled on, the band information indicates band information where a service of the broadcast session scheduled on, and the coverage information indicates coverage information for a service of the broadcast session.
